(19) United States
(12) Patent Application Publication
(10) Pub. No.: US 2008/0103970 A1
(43) Pub. Date: May 1, 2008

(54) Debit card system loan provisions

(75) Inventors: Gregory J. Books, Omro, WI (US); Mark E. Seifert, Menasha, WI (US)

Correspondence Address: WILHELM LAW SERVICE, S.C., 100 W LAWRENCE ST, THIRD FLOOR, APPLETON, WI, 54911, US

(73) Assignee: G & T Management, LLC, Omro, WI (US)

(21) Appl. No.: 11/980,165

(22) Filed: Oct. 29, 2007

Related U.S. Application Data
(60) Provisional application No. 60/854,907, filed on Oct. 27, 2006.

(51) Int. Cl. G06Q 40/00

(52) U.S. Cl. 705/39

(57) ABSTRACT

Debit card systems having loan provisions, and methods of use. Such systems couple a debit card to a financial account having access to the national eft system. The debit card system satisfies the requirements of TISA Regulation DD. Debit card accounts of the invention enable the card holder to access proceeds of short-term loans using the debit card. When coupled with deposit of the card holder's payroll into the card account, by the card holder's employer, such short-term loans are automatically repaid when the employer makes a payroll deposit. Card systems of the invention satisfy the notice provisions of TISA regulation DD by funding the debit card account with loan proceeds only after the card holder has received notification of the conditions, fees, and other costs, and releasing such funds for withdrawal through e.g. an ATM only pursuant to requests therefore received after the card holder has approved such conditions, fees, and other costs.

### BACKGROUND

This invention relates generally to methods and systems which use debit card transactions to electronically transfer funds to a financial account of a card holder, and to enable the card holder to transfer funds from that financial account to destinations of his or her choosing.

As described specifically herein, the invention relates to methods and systems which use payroll debit cards to electronically deposit payroll funds, namely an employee's periodic payment for labor, to a financial account of the employee, thereby to enable the employee to access his or her payroll funds for his or her personal use by employing the respective debit card.

Further as described herein, this invention relates to methods and systems which use such payroll debit cards, and wherein the payroll debit card can be used by the employee/card holder to access short term loans.

Specifically as described herein, this invention relates to methods and systems which use such payroll debit cards and wherein such debit cards can be used to access short term loans, and wherein each future payroll deposit to the card account, by any employer, to the extent of the amount of the payroll deposit, is first used to repay any and all such loans which have been accessed by use of such payroll debit card or card account. Repayment of such loans from payroll deposits includes payment of loan fees and other charges which have been incurred as part of such short term loan.

Many people in a first societal group live from payday to payday. Restated, such people routinely spend all of the money they receive in a given payroll payment by the time they receive the next payroll payment from their employer.

When an unexpected expense arises, for example a medical expense which is not covered by insurance, or an unexpected vehicle repair, such people have no resources to draw on to pay such expense. Namely, such people have no financial reserve from which to get money to make such payments. Accordingly, it would be desirable for such people to have access to a reserve source of readily available funds to meet such unexpected needs.

In addition, many employees in a second societal group do not have a banking relationship, namely they have no bank account. For these employees, it can be expensive to convert a paper payroll check into cash, because they must rely on a business other than a bank to convert their payroll check into cash. For this group of employees, it would be desirable to receive payroll payments in a form other than a paper check. While cash would be acceptable to many such employees, the employer incurs substantial liability risk and loss risk if the employer collects a large amount of cash in one place for the purpose of paying employees in cash.

While the segment of society which lives from payday to payday and the segment of society which has no banking relationship are identified separately, there is a substantial overlap in that individuals in one of these groups often are also included in the other group. And while the above difficulties affect multiple economic levels of society, the difficulties are most common where the person's income is relatively low.

Two different solutions have been developed to meet the above two difficulties.

Regarding the first group, where a person has a need for a short-term loan, e.g. until the next pay day, a lending segment of the finance industry has been developed, and is commonly known as “payday lending”. Payday lenders make payday loans. Payday loans are generally available to anyone who has ongoing employment. At the time the borrower initiates the loan, the borrower receives the proceeds from the loan, and gives the lender a post-dated check for the amount of the loan plus all costs associated with the loan. Typically, the post-dated date on the check is the borrower's next payday, or perhaps the day after the borrower's next payday. Thus, the lender is relatively assured of being able to process the check on the date written on the check because a generally predictable payroll deposit has been recently made into the borrower's bank account.

The above process works only if the employee/borrower has a banking relationship, namely a checking account which can be used in support of the repayment check. But if the employee/borrower does not have a checking account, the payday lending system is not able to meet this person's need for a short-term loan.

Regarding the second group, for the person who has no banking relationship, but does not necessarily live financially from payday to payday, a suitable solution is a payroll debit card. With a payroll debit card, the employer deposits an amount corresponding to the employee's net pay into a financial account which is associated with the debit card. Once the net pay amount has been deposited by the employer, the employee can readily access the money using an automatic teller machine (ATM), or can make purchases by routine use of the card. And indeed such person/employee thereby does have a banking-type relationship, namely the account which the employer has caused to be established for the purpose of supporting the debit card transactions.

Payroll debit cards are conventionally available, and are being increasingly used. Without a line of credit being associated with the card, the card holder is unable to use the card to access funds once the funds in the account are exhausted.

Until recently, regulations allowed the holder of a payroll debit card to contract with the issuer of the card, or other entity, to access a short-term line of credit from a credit provider, through the card issuer or card processor, by simply continuing to use the card, whether e.g. to make a purchase or to draw cash from an ATM, even after the funds in the account were exhausted. And when such credit service was available, such service did serve the needs of those, who had payroll debit cards, who also needed short-term loans. However, every time the card holder used the card to access cash or to make a purchase, while drawing on the loan features of the card, each such transaction was treated by the lender as a separate loan transaction. And each such loan transaction incurred one or more fees associated with the loan transaction.

Recently-enacted US Federal Reserve System TISA Regulation DD states that effective Jan. 1, 2007, if a debit card transaction, such as an ATM transaction, or a point-of-purchase transaction, involves automatic operation of overdraft protection, or an automatic loan, as a feature of that specific account, then the ATM terminal or point of purchase terminal, as applies, must notify the customer of the pending overdraft/loan and any fees the user will incur if the overdraft/loan transaction proceeds.

The reasoning behind Regulation DD was that the industry was charging substantial fees for use of short-term loans made on payroll debit cards, allegedly without making adequate disclosure, to the card holder, of the costs of such loans.

Given the costs involved in re-programming all ATM's and/or all point-of-purchase terminals, providers of payroll debit cards have not been willing to re-program the large number of ATM's and/or point-of-purchase terminals which are in service, and all of which would need to be re-programmed to satisfy TISA Regulation DD. As a result, the finance industry has canceled all payroll debit card-based overdraft loan services in the United States. Accordingly, US Federal Reserve System's TISA Regulation DD has effectively eliminated this segment of the credit market.

However, there remains a strong consumer demand for a debit card service, including a payroll debit card service, which is coupled with short term loans which can be accessed through the debit card.

There is further a demand for a less expensive method for an employee to access his or her payroll cash without having to pay a substantial sum to a service provider who provides such transaction.

While a payroll debit card can provide, to an employee who has no other banking relationship, ready access to his or her payroll funds, the payroll debit cards presently available are not supported by a lending system which satisfies TISA Regulation DD, and which enables the card holder to access a short-term loan through the debit card. The person who has a banking relationship, namely no checking account, can use payday lenders to access such short-term loans. But the person who has no banking relationship does not have access to short-term e.g. payday loans because they have no way to write a post-dated check to the lender. Thus, the demise of payroll debit cards having short-term loan feature has resulted in effective withdrawal of the finance industry from serving the short-term loan needs of anyone who does not have a banking relationship, namely a checking account.

It is thus desirable to provide a debit card, and an associated financial account, where the financial system which supports the debit card includes a mechanism by which a short-term loan can be loaded onto the card at the request of the card holder.

It is also desirable to provide a payroll debit card, and an associated financial account, where the financial system which supports the debit card includes a mechanism by which a short-term loan can be loaded onto the card at the request of the card holder, and wherein the short-term loan is repaid, as a first-in-line recipient, from any funds which are deposited into the account, including any deposits made by any employer of the card holder.

It is further desirable to provide a payroll debit card, and an associated financial account, where the financial system which supports the debit card includes a mechanism by which a short-term loan can be loaded onto the card at the request of the card holder, and wherein the short-term loan is repaid, as a first-in-line recipient, from any funds which are deposited into the account, including any deposits made by any employer of the card holder, and wherein relevant credit bureaus are advised of the full repayment of the loan when each such loan is repaid in full, thereby tending to establish a generally positive credit rating for the card holder.

Any and all loan features of such debit cards must meet TISA Regulation DD, and any and all other governmental regulations which apply to such loan transactions, including repayment of such loans.

### SUMMARY OF THE INVENTION

This invention provides a debit card, coupled to a financial account which has access to the national electronic funds transfer (eft) system, and a card support system, which solves the problem of automatic overdraft protection, while being responsive to, and satisfying the requirements of, TISA Regulation DD. Debit card accounts of the invention provide the consumer with the option of accessing the proceeds of short-term loans by way of the debit card. When coupled with deposit of the employee's net pay into the financial account which is associated with the debit card, by the card holder's employer, short-term loans provided to the card holder are automatically repaid when the employer makes a payroll deposit to the financial account which is associated with the debit card, or any time funds are received from any other source. Specifically, debit card systems of the invention satisfy the notice provisions of TISA regulation DD by activating the loan transaction, and funding the debit card account with the loan proceeds, completely separately from, and prior to, the card holder requesting withdrawal of any such loan proceeds through e.g. an ATM or point-of-purchase transaction. The approval process, and notice of terms, and consent of the borrower, are thereby isolated, as separate events, and isolated in time, from any withdrawal of funds by the borrower.

In a first family of embodiments, the invention comprehends a method of handling a short-term loan in a debit card account in which transactions into and out of the debit card account pass through a debit card processor. The method comprises a debit card holder contacting a loan application processor as a borrower and submitting an application for a short-term loan; the loan application processor processing the loan application in accord with pre-established parameters based on which the loan application can be approved or not approved; where the loan can be approved, the loan application processor advising the borrower that the loan has been approved, and advising the borrower of the conditions, and fees and other costs, associated with the loan; after the loan application processor advises the borrower of the conditions, and fees and other costs, associated with the loan, the borrower approving the conditions, and fees and other costs, associated with the loan; after the borrower approves the conditions, and fees and other costs, evidenced by recorded consent of the borrower by telephone or disclaimed consent if the loan application is presented on the internet, the loan application processor causing net loan proceeds to be deposited into the debit card account of the borrower, through the debit card processor; and after the loan proceeds are transferred to the card holder's debit card account, the card holder requesting access to the loan proceeds, receiving such loan proceeds and using the loan proceeds as desired.

In some embodiments, after the net loan proceeds have been deposited into the debit card account of the borrower, the debit card processor withdraws funds from the debit card account any time funds are next deposited into the debit card account, up to the amount required to satisfy the short-term loan, including all costs and fees.

In a second family of embodiments, the invention comprehends a method of establishing a payroll debit card system having loan provisions. The method comprises establishing an ongoing relationship between a credit provider and a debit card processor; establishing an ongoing relationship between the credit provider and a loan application processor; establishing a relationship between the credit provider and an employer of a debit card holder, by which relationship the credit provider can access employment information pertaining to the debit card holder; and establishing a protocol whereby the credit application processor processes a loan request, advises such debit card holder of the fees, other costs, and conditions associated with such loan, and obtains the card holder's approval of such fees, other costs, and conditions before transferring loan proceeds into the account which is associated with the respective debit card holder, and wherein such loan proceeds must have been deposited into the debit card account before the card processor receives any request, as a separate transaction, distinct in time from the transfer of the net loan proceeds into the debit card account, to withdraw any such loan proceeds, which withdrawal request can be approved.

In some embodiments, the method further comprises establishing a relationship between the employer and the debit card system wherein the employer routinely deposits net payroll proceeds of the debit card holder into the debit card holder's debit card account.

In some embodiments, the method further comprises establishing a protocol between the credit provider and the debit card processor whereby the debit card processor withdraws funds from the debit card account up to the amount required to fully satisfy the loan, including all fees and costs associated with the loan, as soon as any funds are deposited into the payroll debit card account.

In a third family of embodiments the invention comprehends a payroll debit card system, comprising a first party payroll debit card provider, set up to receive and process transactions for a customer, in a customer account in a payroll debit card system; a second party employer, set up to deposit payroll monies into the payroll debit card account; a third party credit provider set up to review and process loan applications, and to transfer loan proceeds to the customer account based on a loan application; a loan approval protocol wherein the customer receives notification regarding conditions, fees, and other costs before any loan request from such customer is funded to the customer's debit card account, and wherein any approval for withdrawal of loan proceeds is necessarily based on a withdrawal request which is received after the customer has received such notification regarding conditions, fees, and costs; and suitable documentation connecting the first, second, and third parties to the customer, thereby to facilitate a loan transaction, funded by the third party, and collected from the card holder account and paid to the third party credit provider when payroll funds are deposited into the payroll debit card account by the second party employer.

In a fourth family of embodiments, the invention comprehends a method of operating a payroll debit card account system, with loan provisions, the method comprising: a first party receiving a loan application from an account holder of a payroll debit card account, and processing such loan application pursuant to pre-established approval criteria; for loan applications which are approved, the first party notifying the account holder regarding conditions, fees, and other costs relating to the loan, and receiving approval of such conditions, fees, and other costs from the account holder, and subsequently causing net proceeds of the loan to be electronically transferred from a credit provider into the card holder's debit card account using a debit card processor, thereby establishing a net loan amount in the debit card account, in favor of the card holder; after the net loan proceeds have been deposited into the debit card account, and as a separate transaction in time, the card holder accessing the net loan proceeds through an approved system node; an employer of the card holder transferring a payroll payment amount into the card holder's payroll debit card account; and repaying the net loan amount due to the credit provider, up to the full amount of the payroll payment amount as needed, using up to the total amount of the payroll payment funds deposited in the account by the employer.

### BRIEF DESCRIPTION OF THE DRAWINGS

FIG. 1 shows a block diagram representation of major elements of a payroll debit card system of the invention, including the various contact points, communication links, and flows of funds in such payroll debit card systems of the invention, including features of the payroll debit card system by which the card user can access short-term loans, and features by which such loans are paid back to the lender.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

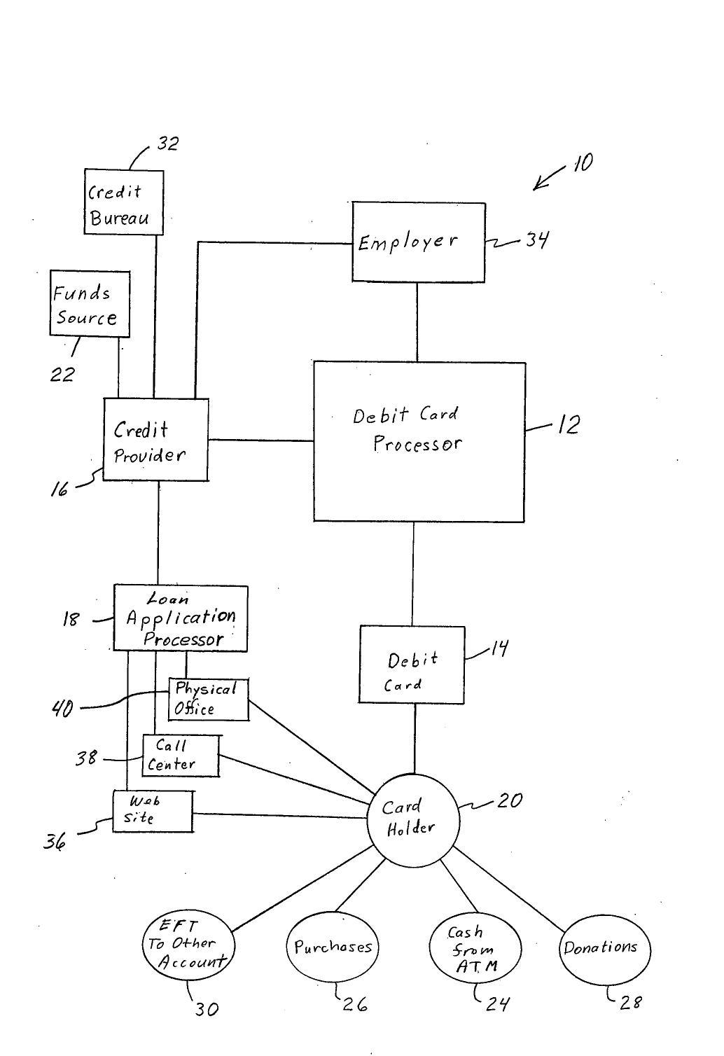

Referring to FIG. 1, a typical debit card system 10 of the invention, having short-term loan features, includes as necessary elements, a debit card processor 12, a debit card 14 having associated with it a financial account at a corresponding financial institution, a credit provider 16, and a loan application processor 18.

Card processor 12 can be any entity which is capable of processing debit card transactions. There can be mentioned, for example and without limitation, a bank or other financial institution. In the alternative, card processor 12 can be a card processing entity which operates outside a banking business, but which is associated with a banking institution as a vendor or a customer, or both, thereby to have access to the national banking system. Every financial transaction involving debit card 14 at some point passes through card processor 12.

Debit card 14 can be issued to, namely given to, or sold to, or bartered to, or otherwise transferred to, a card holder 20 by any of a wide variety of organizations. There can be mentioned, for example and without limitation, the card processor, the credit provider, the card holder's employer, an affinity card beneficiary, a club, a school, a merchant, or any other institution, business, or other entity which has an interest in certain activities, e.g. financial activities, of the card holder.

Debit card 14 is physically a conventional debit card bearing electronically readable information, whereby the debit card can be used in conventional ways to transact all monetary transactions which are commonly transacted using conventional debit cards. Thus, debit card 14 can be used to withdraw cash at an ATM 24. Debit card 14 can be used to make purchases from merchants 26 who accept debit cards. Debit card 14 can be used to make donations to e.g. non-profit organizations 28 which have established relationships with card processors thereby to accept electronic funds transfers which are initiated by debit card transactions. Debit card 14 can be used to transfer funds to other designated financial accounts 30 through the electronic funds transfer (eft) system. Namely, debit cards 14 used in the invention can be used to do anything which can be done with other e.g. conventional debit cards which do not have such loan provisions as are provided for in the invention. Thus, debit cards 14 of the invention provide to the card holder all of the features of a conventional debit card, and in addition provide short-term loan features which meet the requirements of TISA Regulation DD.

Credit provider 16 can be any entity which is capable, and desirous, of funding credit e.g. loan transactions which flow through the debit card account. Credit provider 16 can be e.g. part of the same business as card processor 12. For example, card processor 12 and credit provider 16 can be part of a bank, part of an insurance company, or part of any other entity authorized by law and regulation to transact such credit provider and card processing services in return for payment therefore.

Credit provider 16 provides the money which is used to fund short-term loans which are requested, and accessed, by card holders by use of debit cards 14 in the invention. Credit provider 16 is also the recipient of the net proceeds of loan repayments when a short-term loan is paid back.

Application processor 18 can be any entity which is capable, e.g. qualified by technical capabilities, by all applicable statutes, and by all applicable regulations, to process credit applications from card holders. For example and without limitation, application processor 18 can be part of credit provider 16, or can be owned by credit provider 16 or can own or control credit provider 16. Or application processor 18 can be operating under contract with credit provider 16. Or application processor can be operating under a contract with card processor 12, with a corresponding contract between credit provider 18 and card processor 12. Where credit provider 16 and card processor 12 are parts of a common entity, or are controlled by a common entity, application processor 18 may also be part of the same entity, or may be controlled by the same entity.

Application processor 18 receives credit applications from holders of debit cards 14, and processes such credit applications. In some instances, the application processor operates a physical office 40 where the card holder can physically enter the application processor's office and apply for a loan in person. In some instances, the application processor operates a call center 38 which receives the credit application from the card holder by telephone call. In some instances, the application processor operates a web site 36, or other electronically-accessible location, which can be accessed e.g. by personal computer or other wire or wireless electronic communication device which is capable of accessing either the internet or other universally-available electronically-accessible location which is generally available to the public, or which can be otherwise accessed by persons who have previously received approval for such access.

A typical application processor 18 operates both a call center which receives and processes credit applications by phone calls, and a web site which receives and processes applications through e.g. personal computer access to the internet. In a typical credit application, the card holder either places a telephone call to the call center and applies for credit over the phone; or accesses the application processor's web site through the internet, and fills out a credit application, and submits the credit application to the application processor through the internet.

The application processor receives the application, and screens the application with respect to pre-determined credit parameters established by the credit provider. In some embodiments, the application processor advises the card holder in real time whether or not the credit application can be or has been approved. Where the application has been approved in real time by phone, the application processor can advise the card holder, during the same phone call, of the approval, and can advise the card holder of nodes, local to the card holder, where the loan proceeds can be accessed, e.g. through an ATM or point of purchase or other merchant service.

Where the application has been approved in real time from an internet application, and the fees, terms, and other conditions have been disclosed and accepted by the borrower, the application processor can subsequently send an email or other real-time internet-based communication to e.g. the card holder's computer advising that the credit application has been approved, and further advising where the loan proceeds can be accessed. e.g. through an ATM or point of purchase or other merchant service. However, before the loan processing is completed, the card holder further interacts with the web site by approving the fees, terms, and other conditions as part of the loan approval process, thus permanently establishing the card holder's approval.

In light of the above, any relationship or relationships between card processor 12, credit provider 16, and application processor 18, which are satisfactory to the respective card processor, credit provider, and/or application processor, and which comply with existing statutes and regulations, can satisfy the requirements of the debit card systems of the invention.

In some instances, credit provider 16 funds the loans internally. In other instances, credit provider 16 draws the loan funds from an external fund source 22.

With the debit card system described above, a card holder 20 can obtain cash at an ATM. The card holder can also make purchases at a point of sale. Further, the card holder can make donations to any organization which has set up an account to receive funds electronically. Yet further, the card holder can make eft transactions which transfer funds to certain other accounts as desired.

In addition, the debit card system described above has the capacity to extend loans which meet TISA Regulation DD. However, a substantial issue with the societal group which lives financially from pay day to pay day, and with the societal group which has no banking relationship is that a loan to such person comes with significant risk that the loan will not be repaid on time, if at all. Thus, while such persons have strong desires to be able to avail themselves of short-term loans, lenders are interested in making such loans only where there is a mechanism in place which reduces the risk of nonpayment of such loan when due.

The debit card system described so far does not provide such risk-reducing repayment mechanism, whereby card holders who live financially from pay day to pay day, and card holders who have no other banking relationship, typically are not approved for loans within such debit card systems. Namely, while the debit card system 10 described so far is functional to process loans, credit provider 16 has little incentive to approve a loan request because the risk of non-repayment of the loan is higher than is acceptable to commercial credit providers. Namely, the credit provider must rely on the card holder's credit score, such as a credit score from a credit bureau 32, for assurance that the loan will be repaid. But historically, prospective customers in the societal groups discussed above either have no credit rating with established credit bureaus, or have a low credit rating which discourages a credit provider from granting the loan request.

Thus, while not critical to functionality of the debit card system, a typical system of the invention includes links to the card holder's employer 34, as well as including additional conditions placed on the card holder when a loan request/credit application is received and processed.

The additional conditions placed on the card holder when a loan request is received and processed specify that the loan, including all fees and other costs associated with such loan, will be repaid by electronic funds transfer/withdrawal, on a first-in-line basis, from any and all funds deposited in the debit card account after the loan is granted and loan funds have been transferred to the debit card account. Such conditions specifically state that payroll funds deposited by an employer of the card holder are immediately subject to such withdrawal/electronic funds transfer.

The links to the employer are two-fold. First, the employer agrees to deposit all payroll monies payable to the card holder into the card holder's debit card account. Second, the employer agrees to provide credit provider 16 or its designee with employment information about the card holder any time the card holder makes a credit application, requesting a short-term loan through the card holder's debit card account.

With the employer thus linked into the debit card account system, two more features have been added to the system. First, payroll funds are transferred electronically from the employer to the card holder's account on each pay day as long as the card holder is employed by the employer. Second, the debit card system is structured such that the credit provider can electronically and substantially immediately obtain, from the employer, employment information with respect to each card holder who is employed by the respective employer. The employer thus maintains a regularly-updated employee database having current information regarding each such card holder who is employed by that employer. Within the debit card system, the information in such database is made electronically available to the credit provider for each employee who is also a card holder in the debit card system.

The linking of the employer into the debit card system such that the employer deposits the card holder's payroll payments into the debit card holder's account converts the debit card system 10 into a “payroll debit card” system. By linking such payroll debit card system to a loan feature which meets the requirements of TISA Regulation DD, debit card system 10 is a payroll debit card system having a loan feature. Such debit card system thus provides the short-term loan services desired by the two societal groups which (i) have no banking relationship, and/or (ii) live financially from pay day to pay day.

In addition to the above features of the debit card systems of the invention, an additional feature which can be included is that, every time such short-term loan is repaid, credit provider 16 reports such repayment to one or more of the established credit bureaus 32. Such reporting of the repayment of such loans operates to create a credit score for the card holder. If and as the card holder avails himself or herself of such loans over time, and repays such loans on a timely basis, albeit through employer payments to the card holder's debit card account, the card holder obtains a favorable credit score, which can be used to obtain conventional financing on more favorable terms.

A typical payroll debit card system 10 of the invention is structured generally as follows.

A credit provider 16 enters into a relationship, typically a contract, with a payroll debit card processor 12, typically a bank, for the purpose of acquiring contractual rights to distribute a payroll-based debit card 14.

Credit provider 16 develops relationships, systems, and services, as necessary, to supply and activate an interactive internet web site 36, capable of receiving and processing applications for credit, including approving or rejecting such applications according to pre-established criteria by which such applications are to be adjudged, and capable of causing funds to be disbursed by credit provider 16 via electronic ach/eft, to card holders 20 whose applications for credit have been approved, namely to holders of corresponding payroll debit cards.

Credit provider 16 also develops relationships, systems, and services, as necessary, to establish and activate a call center 38 capable of receiving and processing applications for credit by telephone calls, and capable of causing funds to be disbursed by credit provider 16 via electronic ach/eft transfer to the accounts of card holders 20 whose applications for credit have been approved, namely to holders of corresponding payroll debit cards.

Credit provider 16 also develops relationships, systems, and services, as necessary, to establish a funding source 22, optionally a third party funding source, to capitalize approved credit/loan transactions.

Credit provider 16 also develops relationships, systems, and services, as necessary, to establish a marketing system to market the payroll debit card product to consumers and employers and other potential purchasers of the debit card product and its supported services. The marketing system can include, for example and without limitation, materials supplied by the payroll debit card processor, or other card provider, as well as any and all sales materials, sales processes and systems, and the intellectual property developed, created and used by credit provider, which are designed to advance the sale of the card and/or the card service, and/or to assist in processing credit/loan applications via telephone or interactive web-site processing, and/or to accomplish the funding of extensions of credit via the system electronically into the payroll debit card account via ach/eft processing. The marketing system can further include all the software and data systems used in carrying out the afore-mentioned marketing, processing, and/or disbursing functions, or in carrying out direct sale or advertising of the products and services associated with payroll debit card system 10, as well as any software and/or materials produced by the software as well as documents produced by or reduced to writing or recorded from the software and/or systems.

Credit provider 16 also establishes relationships, systems, and methods, as necessary, to establish an electronic protocol by which credit provider 16 can electronically access employment information about a card holder 20 from his or her employer 34.

Credit provider 16 optionally also establishes relationships, systems, and methods to establish an electronic communications link with one or more of the established credit bureaus 32 by which credit provider 16 can report, to such one or more established credit bureaus, the credit transactions which take place between the credit provider and respective ones of card holders 20.

Sample Transactions Via Web Site 36:

An exemplary credit application procedure at web site 36 develops generally as follows.

Card holder 20 initiates contact with the loan application processor's web site 36. Web site 36 identifies the card holder via user name and password and/or any other acceptable means of authentication and/or identification of the card holder. After completion of card holder authentication, card holder 20 accesses his/her personal “Payroll Advance Account” on web site 36.

Card holder 20 completes a payday advance credit application on web site 36, requesting a short-term loan.

Interactive web site 36 discloses to card holder 20 all terms and conditions of the credit/loan transaction, including conditions for approval, terms of repayment and all relevant costs, rates and fees associated with such loan, meeting all of the requirements of TISA Regulation DD.

Still using web site 36, the card holder approves the conditions, terms, costs, rates, and fees and submits his/her credit application through the web site, including authorization for the credit provider and/or loan application processor to contact the card holder's employer and to receive from the card holder's employer all needed information regarding his/her employment status. Web site software promptly queries the employer database electronically, and processes the data received therefrom against pre-established parameters against which such loan applications are to be adjudged.

If the credit application is promptly approved e.g. in real time, web site 36 promptly notifies the card holder of such approval, notifies the card holder of any special conditions related to the approval, the amount of money which has been approved for disbursement in the loan, and the time at which the loan proceeds will become available.

Web site 36 also confirms to the card holder, at the same time, all costs and conditions, and any other relevant information associated with the loan, including all information required by law or regulation.

Web site 36 also advises the card holder of locations, typically convenient to the card holder's then-current location, where the card holder can access the proceeds of the loan, such locations as, for example and without limitation, a point of sale e.g. a participating merchant, an ATM, a bank, or other approved funds disbursing location.

Card holder 20 gives final approval to the transaction, including authorizing electronic assignment/repayment of this loan, via the very next wages/payroll payments which will be deposited into the payroll debit card account e.g. by any employer 34, to be withdrawn by card processor 12 from such deposits and paid via ach/eft to an account specified by credit provider 16, no later than the card holder's next pay day.

Application processor 18 then causes credit provider 16 to load the loan proceeds into the card holder's payroll debit card account through the debit card processor. In the alternative, subject to approval by credit provider 16, application processor 18 can, itself, load the loan proceeds into the card holder's payroll debit card account through debit card processor 12.

Card holder 20 accesses the loan proceeds through a point of sale merchant, an ATM, or at a bank or other authorized access node.

Card holder 20 uses the loan proceeds, and otherwise uses the payroll debit card as he/she desires and in accord with the contracts, terms, and conditions established with debit card processor 12 and credit provider 16.

On the next pay day, employer 34 electronically transfers the card holder's net payroll monies to the financial account which is associated with the card holder's payroll debit card, through debit card processor 12.

Acting under the direct payment authorization authorized by the card holder at the time when the loan was originated through the credit application at web site 36, which payment authorization includes all relevant information, including but not limited to the principle and interest, fees, and other charges to the account and the appropriate account information of each party, card processor 12 pays the amount of money necessary to repay all funds borrowed, and all interest, fees, and other charges, directly to the specified account of credit provider 16, thus repaying the loan all as agreed to by the card holder during the loan application process, to the extent payroll monies are available.

Assuming sufficient funds have been deposited into the account to satisfy all demands and charges associated with the loan, the loan account is recorded as having been paid in full, whereupon the credit provider notifies the card holder and all credit bureaus that the loan obligation has been fully satisfied, with all monies paid in full.

Sample Transactions Via Telephone:

Card holder 20 initiates contact with a customer service representative of loan application processor 18 by telephone. The customer service representative verifies the card holder's identity by user name and password, and/or any other acceptable means of verification. Upon appropriate verification of the caller's identity, the customer service representative grants the card holder access to the card holder's personal payroll advance account.

Card holder 20 completes the payday advance credit application, requesting a short-term loan, with the assistance of the loan application processor's customer service representative, over the telephone.

The customer service representative, while being recorded, discloses to the card holder all terms and conditions of the credit/loan transaction as required by TISA Regulation DD, including the conditions for approval, terms of repayment, and all relevant costs, rates and fees associated with such loan, satisfying all conditions of TISA Regulation DD.

Still in the same telephone call, card holder 20 approves the terms, conditions, costs, rates, and fees, and authorizes submission of the application, including authorization for the credit provider and/or loan application processor to contact the card holder's employer and to receive from the card holder's employer all needed information regarding the card holder's employment status, while the conversation is still being recorded, whereby the card holder's approval is permanently made of record. The loan application processor promptly queries the employer database electronically, and processes the data received therefrom against pre-established parameters against which such loan applications are to be adjudged.

If the credit application is promptly approved e.g. in real time, the customer service representative promptly advised the card holder of such approval during the same telephone call, notifies the card holder of any special conditions related to the approval, the amount of money which has been approved for disbursement under the loan, and the time at which the funds will be available for disbursement.

The customer service representative also confirms to the card holder at the same time, all costs and conditions, and any other relevant information, including all information required by law or regulation, related to the loan.

The customer service representative also advises the card holder of locations, typically convenient to the card holder's then-current location, where the card holder can access the proceeds of the loan, such locations as, for example and without limitation, an ATM, a point of sale merchant, a bank, or other approved funds disbursing location.

Card holder 20 gives final approval to the transaction to the customer service representative, including authorizing electronic assignment/repayment of this loan, including by way of the very next wages/payroll payments which will be deposited into the payroll debit card account e.g. by an employer, to be withdrawn by debit card processor 12 from such deposits, and paid via ach/eft to an account specified by credit provider 16, no later than the card holder's next pay day.

Once the loan application has thus been processed and accepted, the application processor causes credit provider 16 to load the proceeds of the loan into the card holder's payroll debit card account through debit card processor 12. In the alternative, subject to approval by credit provider 16, application processor 18 can, itself, load the loan proceeds into the card holder's payroll debit card account through debit card processor 12.

Card holder 20 accesses the loan proceeds via such point of sale, ATM, bank, or other authorized access node/location.

Card holder 20 uses the loan proceeds, and otherwise uses the payroll debit card as he/she desires, and in accord with the contracts, terms, and conditions established with loan application processor 18 and/or credit provider 16.

On pay day, employer 34 electronically transfers the card holder's net payroll monies to the financial account which is associates with the card holder's payroll debit card, through debit card processor 12.

Acting under the direct payment authorization authorized by the card holder at the time when the loan was originated with the customer service representative at call center 38, which payment authorization includes all relevant information, including but not limited to the principle and interest, fees, and other charges to the account and the appropriate account information of each party, card processor 12 pays the amount of money necessary to repay all funds borrowed, and all interest, fees, and other charges associated with the loan directly to the specified account of credit provider 16, all as agreed to by the card holder during the loan application process, to the extent payroll monies are available.

Credit provider 16 credits the card holder's account whereby, assuming the payroll deposit amount is sufficient to satisfy all demands and charges associated with the loan, the loan account is marked as paid in full, whereupon the credit provider advises the card holder and all credit bureaus that the loan obligation has been fully satisfied, with all monies paid in full.

While the application of debit card system 10 having an accompanying loan feature has been described as part of a payroll debit card system, those skilled in the art will recognize that debit card system 10 can be used with or without an accompanying payroll feature. Accordingly, all debit card systems having attached third-party credit providers, and wherein the card is pre-loaded with the disbursed loan funds before the card holder draws any of such funds, and wherein the card holder receives all of the disclosures required by law and regulation, including all such disclosures required by TISA Regulation DD, are included within the scope of the invention.

While the description herein discusses real-time approvals of loan applications, additional time may be used in approving certain loan applications where certain conditions apply. Thus, some or all such loan applications may be subjected to longer processing times e.g. 24 hours, 48 hours, or more, for the purpose of e.g. gathering additional data or providing additional human intervention in the loan application process.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A method of handling a short-term loan in a debit card account in which transactions into and out of the debit card account pass through a debit card processor, the method comprising:
(a) a debit card holder contacting a loan application processor as a borrower and submitting an application for a short-term loan;
(b) the loan application processor processing the loan application in accord with pre-established parameters based on which the loan application can be approved or not approved;
(c) where the loan can be approved, the loan application processor advising the borrower that the loan has been approved, and advising the borrower of the conditions, and fees and other costs, associated with the loan;
(d) after the loan application processor advises the borrower of the conditions, and fees and other costs, associated with the loan, the borrower approving the conditions, and fees and other costs, associated with the loan;
(e) after the borrower approves the conditions, and fees and other costs, the loan application processor causing net loan proceeds to be deposited into the debit card account of the borrower, through the debit card processor; and
(f) after the loan proceeds are transferred to the card holder's debit card account, the card holder requesting access to the loan proceeds, receiving such loan proceeds and using the loan proceeds as desired.

2. A method as in claim 1 wherein, after the net loan proceeds have been deposited into the debit card account of the borrower, the debit card processor withdrawing funds from the debit card account any time funds are next deposited into the debit card account, up to the amount required to satisfy the short-term loan, including all costs and fees.

3. A method of establishing a payroll debit card system having loan provisions, the method comprising:
(a) establishing an ongoing relationship between a credit provider and a debit card processor;
(b) establishing an ongoing relationship between the credit provider and a loan application processor;
(c) establishing a relationship between the credit provider and an employer of a debit card holder, by which relationship the credit provider can access employment information pertaining to the debit card holder; and
(d) establishing a protocol whereby the credit application processor processes a loan request, advises such debit card holder of the fees, other costs, and conditions associated with such loan, and obtains the card holder's approval of such fees, other costs, and conditions before transferring loan proceeds into the account which is associated with the respective debit card holder, and wherein such loan proceeds must have been deposited into the debit card account before the card processor receives any request, as a separate transaction, distinct in time from the transfer of the net loan proceeds into the debit card account, to withdraw any such loan proceeds, which withdrawal request can be approved.

4. A method as in claim 3, the method further comprising establishing a relationship between the employer and the debit card system wherein the employer routinely deposits net payroll proceeds of the debit card holder into the debit card holder's debit card account.

5. A method as in claim 5, the method further comprising establishing a protocol between the credit provider and the debit card processor whereby the debit card processor withdraws funds from the debit card account up to the amount required to fully satisfy the loan, including all fees and costs associated with the loan, as soon as any funds are deposited into the payroll debit card account.

6. A payroll debit card system, comprising:
(a) a first party payroll debit card provider, set up to receive and process transactions for a customer, in a customer account in a payroll debit card system;
(b) a second party employer, set up to deposit payroll monies into the payroll debit card account;
(c) a third party credit provider set up to review and process loan applications, and to transfer loan proceeds to the customer account based on a loan application;
(d) a loan approval protocol wherein the customer receives notification regarding conditions, fees, and other costs before any loan request from such customer is funded to the customer's debit card account, and wherein any approval for withdrawal of loan proceeds is necessarily based on a withdrawal request which is received after the customer has received such notification regarding conditions, fees, and costs; and
(e) suitable documentation connecting the first, second, and third parties to the customer, thereby to facilitate a loan transaction, funded by the third party, and collected from the card holder account and paid to the third party credit provider when payroll funds are deposited into the payroll debit card account by the second party employer.

7. A method of operating a payroll debit card account system, with loan provisions, the method comprising:
(a) a first party receiving a loan application from an account holder of a payroll debit card account, and processing such loan application pursuant to pre-established approval criteria;
(b) for loan applications which are approved, the first party notifying the account holder regarding conditions, fees, and other costs relating to the loan, and receiving approval of such conditions, fees, and other costs from the account holder, and subsequently causing net proceeds of the loan to be electronically transferred from a credit provider into the card holder's debit card account using a debit card processor, thereby establishing a net loan amount in the debit card account, in favor of the card holder;
(c) after the net loan proceeds have been deposited into the debit card account, and as a separate transaction in time, the card holder accessing the net loan proceeds through an approved system node;
(d) an employer of the card holder transferring a payroll payment amount into the card holder's payroll debit card account; and
(e) repaying the net loan amount due to the credit provider, up to the full amount of the payroll payment amount as needed, using up to the total amount of the payroll payment funds deposited in the account by the employer.
